(19) United States
(12) Patent Application Publication
(10) Pub. No.: US 2011/0154959 A1
(43) Pub. Date: Jun. 30, 2011

(54) Hex Wrench Having Greater Strength

(76) Inventor: Liang-Hui Lin, Taiping City (TW)

(21) Appl. No.: 12/648,591

(22) Filed: Dec. 29, 2009

(51) Int. Cl. B25B 23/00

(52) U.S. Cl. 81/436

(57) ABSTRACT

A hex wrench includes a handle (21) and a head (22) connected with the handle. The handle has a surface provided with a first twist portion (212) which has an axis that is not parallel with the axis of the handle, and the head has a surface provided with a second twist portion (222) which has an axis that is not parallel with the axis of the head. Preferably, each of the first twist portion and the second twist portion has a helical profile to conform to the torsional shear stress applied by the hex hole screw during operation of the hex wrench so that the hex wrench has greater strength and stiffness without reducing its malleability so as to prevent the hex wrench from being cracked or broken due to an excessive applying force.

### BACKGROUND OF THE INVENTION

1. Field of the Invention

The present invention relates to a hand tool and, more particularly, to a hex wrench that co-operates a hex hole screw, bolt and the like.

2. Description of the Related Art

A conventional hex wrench 1 in accordance with the prior art shown in FIG. 2 comprises a handle 11 and a head 12 connected with the handle 11. The handle 11 has a distal end provided with a first mounting portion 111. The head 12 has a distal end provided with a second mounting portion 121. In operation, the first mounting portion 111 of the handle 11 or the second mounting portion 121 of the head 12 is inserted into the hexagonal hole of a hex hole screw to rotate the hex hole screw so as to tighten or loosen the hex hole screw. At this time, the handle 11 or the head 12 is subjected to a torsional shear stress that is applied by the hex hole screw during operation of the hex wrench 1. However, the hex wrench 1 is usually made of a medium steel which has a smaller stiffness or hardness to reduce the torsional radius of the hex wrench 1 so that the hex wrench 1 is easily distorted or deformed due to an excessive applying force. Alternatively, the hex wrench 1 can be worked by a heat treatment to increase its stiffness or hardness. However, the malleability of the hex wrench 1 is decreased after the heat treatment to reduce the torque of the hex wrench 1 so that the hex wrench 1 is easily cracked or broken due to an excessive torque.

### BRIEF SUMMARY OF THE INVENTION

In accordance with the present invention, there is provided a hex wrench, comprising a handle and a head connected with the handle. The handle has a surface provided with a first twist portion, and the head has a surface provided with a second twist portion. The first twist portion of the handle has an axis that is not parallel with an axis of the handle, and the second twist portion of the head has an axis that is not parallel with an axis of the head. Preferably, the first twist portion of the handle has a substantially helical profile, and the second twist portion of the head has a substantially helical profile.

The primary objective of the present invention is to provide a hex wrench having a greater strength.

According to the primary objective of the present invention, each of the first twist portion of the handle and the second twist portion of the head has a substantially helical profile to conform to the torsional shear stress applied by the hex hole screw during operation of the hex wrench so that the hex wrench has greater strength and stiffness without reducing its malleability so as to prevent the hex wrench from being cracked or broken due to an excessive applying force, thereby enhancing the lifetime of the hex wrench.

According to another objective of the present invention, each of the first twist portion of the handle and the second twist portion of the head has an axis that is not parallel with the axis of the handle and the head respectively so that the hex wrench has a greater torque to withstand a larger torsional shear stress.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a hex wrench in accordance with the preferred embodiment of the present invention.

FIG. 2 is a perspective view of a conventional hex wrench in accordance with the prior art.

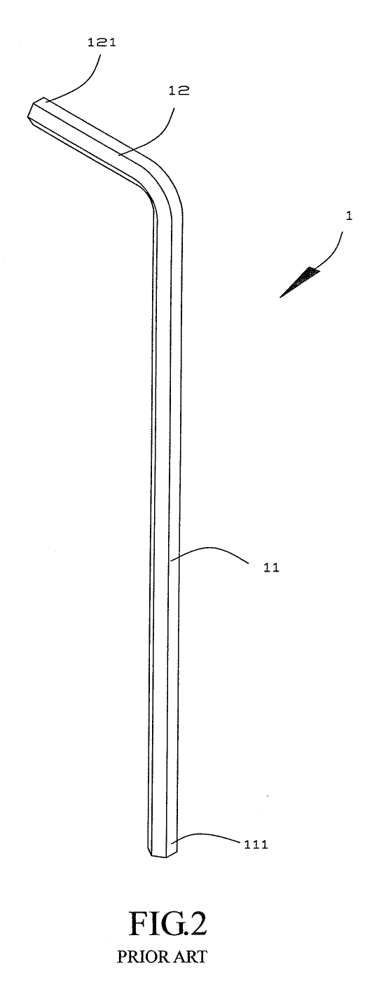

### DETAILED DESCRIPTION OF THE INVENTION

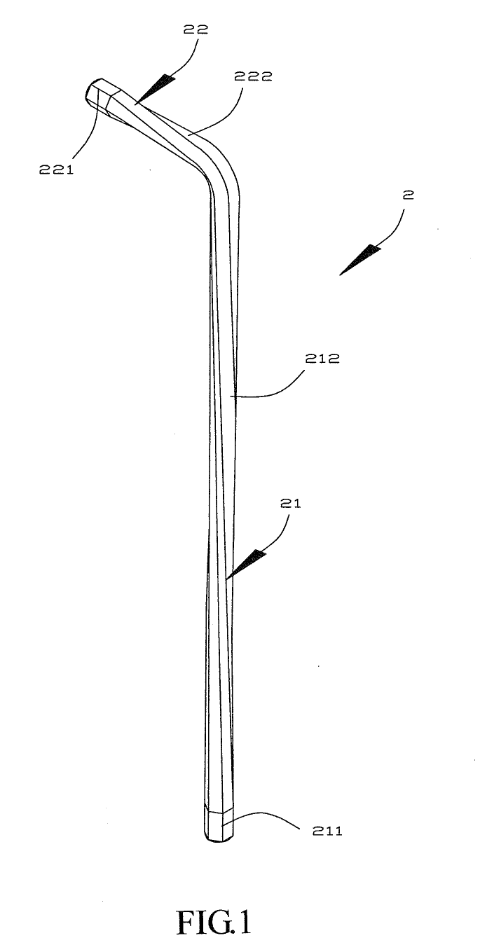

Referring to FIG. 1, a hex wrench 2 in accordance with the preferred embodiment of the present invention comprises a handle 21 and a head 22 connected with the handle 21.

The handle 21 has a distal end provided with a first mounting portion 211. The first mounting portion 211 of the handle 21 has an axis that is parallel with the axis of the handle 21. The handle 21 has a surface provided with a first twist portion 212. The first twist portion 212 of the handle 21 has an axis that is not parallel with the axis of the handle 21. Preferably, the first twist portion 212 of the handle 21 has a substantially helical profile.

The head 22 has a distal end provided with a second mounting portion 221. The second mounting portion 221 of the head 22 has an axis that is parallel with the axis of the head 22. The head 22 has a surface provided with a second twist portion 222. The second twist portion 222 of the head 22 has an axis that is not parallel with the axis of the head 22. Preferably, the second twist portion 222 of the head 22 has a substantially helical profile.

The first twist portion 212 of the handle 21 has a first end connected with the first mounting portion 211 of the handle 21 and a second end connected with the second twist portion 222 of the head 22, and the second twist portion 222 of the head 22 has a first end connected with the second mounting portion 221 of the head 22 and a second end connected with the first twist portion 212 of the handle 21.

In operation, the first mounting portion 211 of the handle 21 or the second mounting portion 221 of the head 22 is inserted into the hexagonal hole of a hex hole screw to rotate the hex hole screw so as to tighten or loosen the hex hole screw. At this time, the handle 21 or the head 22 is subjected to a torsional shear stress that is applied by the hex hole screw during operation of the hex wrench 2. In such a manner, the first twist portion 212 of the handle 21 has an axis that is not parallel with the axis of the handle 21 and has a substantially helical profile, and the second twist portion 222 of the head 22 has an axis that is not parallel with the axis of the head 22 and has a substantially helical profile, so that the first twist portion 212 of the handle 21 and the second twist portion 222 of the head 22 can withstand and tolerate the torsional shear stress applied by the hex hole screw so as to enhance the strength and stiffness of the hex wrench 2 without reducing the malleability of the hex wrench 2 and to prevent the hex wrench 2 from being cracked or broken due to an excessive applying force, thereby enhancing the lifetime of the hex wrench 2.

Accordingly, each of the first twist portion 212 of the handle 21 and the second twist portion 222 of the head 22 has a substantially helical profile to conform to the torsional shear stress applied by the hex hole screw during operation of the hex wrench 2 so that the hex wrench 2 has greater strength and stiffness without reducing its malleability so as to prevent the hex wrench 2 from being cracked or broken due to an excessive applying force, thereby enhancing the lifetime of the hex wrench 2. In addition, each of the first twist portion 212 of the handle 21 and the second twist portion 222 of the head 22 has an axis that is not parallel with the axis of the handle 21 and the head 22 respectively so that the hex wrench 2 has a greater torque to withstand a larger torsional shear stress.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hex wrench, comprising:
a handle (21); and
a head (22) connected with the handle;
wherein the handle has a surface provided with a first twist portion (212);
the head has a surface provided with a second twist portion (222).

2. The hex wrench of claim 1, wherein the first twist portion of the handle has an axis that is not parallel with an axis of the handle.

3. The hex wrench of claim 1, wherein the first twist portion of the handle has a substantially helical profile.

4. The hex wrench of claim 1, wherein the second twist portion of the head has an axis that is not parallel with an axis of the head.

5. The hex wrench of claim 1, wherein the second twist portion of the head has a substantially helical profile.

6. The hex wrench of claim 1, wherein the handle has a distal end provided with a first mounting portion (211).

7. The hex wrench of claim 6, wherein the first mounting portion of the handle has an axis that is parallel with the axis of the handle.

8. The hex wrench of claim 1, wherein the head has a distal end provided with a second mounting portion (221).

9. The hex wrench of claim 8, wherein the second mounting portion of the head has an axis that is parallel with the axis of the head.

10. The hex wrench of claim 1, wherein
the first twist portion of the handle has a first end connected with the first mounting portion of the handle and a second end connected with the second twist portion of the head;
the second twist portion of the head has a first end connected with the second mounting portion of the head and a second end connected with the first twist portion of the handle.
